(19) United States
(12) Patent Application Publication
(10) Pub. No.: US 2017/0315667 A1
(43) Pub. Date: Nov. 2, 2017

(54) Hand or Finger Detection Device and a Method Thereof

(71) Applicant: Huawei Technologies Co., Ltd., Shenzhen (CN)

(72) Inventors: Antti Erik Peuhkurinen, Helsinki (FI); Chris Dimopoulos, Kista (SE)

(21) Appl. No.: 15/654,334

(22) Filed: Jul. 19, 2017

Related U.S. Application Data
(63) Continuation of application No. PCT/EP2015/051643, filed on Jan. 28, 2015.

(51) Int. Cl. G06F 3/041; G06F 3/0488; G06K 9/00

(52) U.S. Cl. CPC G06F 3/0416; G06K 9/00375; G06F 3/04886; G06K 9/00201

(57) ABSTRACT

A hand or a finger detection device and a computing device comprising a hand or a finger detection device includes a proximity sensor grid having a plurality of proximity sensors, and a processor. The proximity sensor grid is configured to provide a sensor image, where the sensor image is a proximity sensor grid representation of a hand or a finger in proximity to the proximity sensor grid. The processor is configured to estimate a finger skeletal model (FSM) of the hand or the finger based on the sensor image, to determine a hand location or a finger location for the hand or the finger based on the estimated FSM, and output a hand location or a finger location in proximity to the proximity sensor grid

### CROSS-REFERENCE TO RELATED APPLICATIONS

This application is a continuation application of International Patent Application No. PCT/EP2015/051643, filed on Jan. 28, 2015, the disclosure of which is hereby incorporated by reference in its entirety.

### TECHNICAL FIELD

The present disclosure relates to a hand or finger detection device and a computing device comprising such a hand or finger detection device. Furthermore, the present disclosure also relates to a corresponding method, a computer program, and a computer program product.

### BACKGROUND

In a lot of computing devices, a user of the computing device inputs instructions or commands via a touch screen or keyboard of the computing device. This allows the user to interact with graphical user interface (GUI) elements and menus that are shown on the screen or the display of the computing device. Examples of such computing devices are smart phones, tablet computers, and laptops with touch screens.

There are software applications for computing devices that work differently depending on if the user uses one hand or two hands. Further, other software applications work better or faster or differently if the user uses its right or left hand. Therefore, hand detection and/or finger detection methods are needed to detect which finger or hand that is used and thus activating appropriate functions associated with the detected hand or finger.

### SUMMARY

An objective of embodiments of the present disclosure is to provide a solution which mitigates or solves the drawbacks and problems of conventional solutions.

An “or” in this description and the corresponding claims is to be understood as a mathematical OR which covers “and” and “or”, and is not to be understand as an XOR (exclusive OR).

The above objectives are solved by the subject matter of the independent claims. Further advantageous implementation forms of the present disclosure can be found in the dependent claims.

According to a first aspect of the disclosure, the above mentioned and other objectives are achieved with a hand or a finger detection device comprising a proximity sensor grid having a plurality of proximity sensors, and a processor, where the proximity sensor grid is configured to provide a sensor image, the sensor image is a proximity sensor grid representation of a hand or a finger in proximity to the proximity sensor grid, and where the processor is configured to estimate a finger skeletal model of the hand or the finger based on the sensor image, determine a hand location or a finger location for the hand or the finger based on the estimated finger skeletal model, and output the hand location or the finger location.

A sensor image is a proximity sensor grid representation of a hand or a finger in proximity to the proximity sensor grid.

A finger skeletal model is a model of the finger bones and its joints.

A hand or a finger detection device configured to determine hand location or a finger location based on a sensor image derived from the proximity sensor grid provides a number of advantages.

The present hand or a finger detection device makes it possible to determine how the hand or finger is located in relation to, for example, a computing device comprising the present hand or a finger detection device. Therefore, with the present hand or finger detection device, it can be determined which hand (left or right hand) or finger touches or is close to the computing device. Based on this information, different user actions can be performed by the computing device.

In a first possible implementation form of a hand or a finger detection device according to the first aspect, the proximity sensor grid further is configured to provide a plurality of sensor images of the hand or the finger in proximity to the proximity sensor grid, and the processor further is configured to estimate a finger skeletal model of the hand or the finger based on the plurality of sensor images.

An advantage with this implementation form is that by using a plurality of sensor images improved resolution and estimation of the hand or finger location is achieved. Another advantage is that change of the location of the hand or the finger is enabled, thereby tracking of the location of the hand or the finger is possible.

In a second possible implementation form of a hand or a finger detection device according to the first implementation form of the first aspect or to the hand or a finger detection device as such, the processor further is configured to estimate the finger skeletal model by estimate finger bone end information, finger bone start information, and finger mesh information of the hand or the finger; and estimate the finger skeletal model based on the estimated finger bone end information, estimated finger bone start information, and estimated finger mesh information. An advantage with this implementation form is that a three dimensional model of the finger skeletal model can be obtained thereby making the finger skeletal model more accurate.

In a third possible implementation form of a hand or a finger detection device according to the second implementation form of the first aspect, the finger bone end is the finger bone tip of a finger; the finger bone start is the first joint of a finger; and the finger mesh is a three dimensional surface representation of a finger. With this implementation form, the finger bone end, finger bone start and the finger mesh are defined.

In a fourth possible implementation form of a hand or a finger detection device according to the second or third implementation form of the first aspect, the processor further is configured to estimate the finger bone end information by using a curvature based algorithm on the sensor image and touch location information. An advantage with this implementation form is that by using the curvature based algorithm and the touch location information, a very efficient solution is provided for obtaining the finger bone end information.

In a fifth possible implementation form of a hand or a finger detection device according to the second, third or fourth implementation form of the first aspect, the processor further is configured to estimate the finger bone start information by using a curvature based algorithm on the sensor image and the finger bone end information. An advantage with this implementation form is that by using the curvature based algorithm and the finger bone end information a very efficient solution is provided for obtaining the finger bone start information.

In a sixth possible implementation form of a hand or a finger detection device according to one of the second to fifth implementation form of the first aspect, the processor further is configured to estimate the finger mesh information by using the finger bone end information and the finger bone start information. An advantage with this implementation form is that it is easier to estimate the finger mesh information by using the finger bone end information and the finger bone start information.

In a seventh possible implementation form of a hand or a finger detection device according to any implementation form of the first aspect or to the hand or a finger detection device as such, the processor further is configured to give each finger in the finger skeletal model a unique identity, and use the unique identities for tracking the location of the hand or the finger. An advantage with this implementation form is that by giving each finger a unique identity the processor can match the most probable finger identity in previous estimations to the current processed finger identity. This makes it possible to obtain information on how much a single finger skeleton model has changed from previous finger skeleton models over time, therefore detecting or tracking movement of the hand or the finger.

In an eight possible implementation form of a hand or a finger detection device according to any implementation form of the first aspect or to the hand or a finger detection device as such, the hand/finger location indicates the location of the hand or the finger in relation to the hand or the finger detection device or the proximity sensor grid. An advantage with this implementation form is that that different application can use this hand or finger location information for configuring an associated computing device. For example, mentioned information can be used for adapting different GUI modes, etc.

According to a second aspect of the disclosure, the above mentioned and other objectives are achieved with a computing device comprising a hand or a finger detection device according to any of the preceding claims, and a Graphic User Interface, GUI, control unit configured to control GUI elements of a GUI of the computing device; where the hand or the finger detection device is configured to provide hand location information or finger location information for a hand or a finger in proximity to a proximity sensor grid of the hand or the finger detection device; and where the GUI control unit is configured to control the GUI elements based on the hand location information or the finger location information.

A computing device comprising the present hand or finger detection device provides a number of advantages.

The computing device can use the hand location information or finger location information for controlling GUI elements in a way so that the user modes and user input adaptation is possible and/or improved. For example, a number of new specific user input events associated with GUI elements can be used by the user since the present hand or a finger detection device has improved ability to detect different gestures performed by the user.

In a first possible implementation form of a computing device according to the second aspect, the hand location information or the finger location information is three dimensional hand location information or finger location information; and where the GUI control unit further is configured to control three dimensional GUI elements in three dimensions based on the three dimensional hand location information or finger location information. An advantage with this implementation form is that, since three dimensional hand location information or three dimensional finger location information is provided, corresponding three dimensional and two dimensional GUI elements can be controlled. Also new three dimensional gestures can be used by users for GUI control.

In a second possible implementation form of a computing device according to the first implementation form of the second aspect or to the computing device as such, the GUI control unit further is configured to arrange the GUI elements in a plurality of different GUI user modes based on the hand location information or the finger location information, wherein each GUI user mode corresponds to a unique GUI layout. An advantage with this implementation form is that GUI elements can be placed more appropriate or convenient for the user of the computing device.

In a third possible implementation form of a computing device according to the first or second implementation form of the second aspect or to the computing device as such, the proximity sensor grid is integrated in the GUI. An advantage with this implementation form is that a compact computing device can be provided when the proximity sensor grid is integrated in the GUI since this solution is very space saving. This is especially advantage when the GUI is a touch screen and the proximity sensor grid is integrated in the touch screen.

According to a third aspect of the disclosure, the above mentioned and other objectives are achieved with a hand or a finger detection method comprising providing a sensor image, where the sensor image is a proximity sensor grid representation of a hand or a finger; estimating a finger skeletal model of the hand or the finger based on the sensor image, determining a hand location or a finger location for the hand or the finger based on the estimated finger skeletal model; and outputting the hand location or the finger location.

In a first possible implementation form of a method according to the third aspect, the method further comprises providing a plurality of sensor images of the hand or the finger in proximity to the proximity sensor grid, and estimating a finger skeletal model of the hand or the finger based on the plurality of sensor images.

In a second possible implementation form of a method according to the first implementation form of the third aspect or to the method as such, the method further comprises estimating the finger skeletal model by estimating finger bone end information, finger bone start information, and finger mesh information of the hand or the finger; and estimating the finger skeletal model based on the estimated finger bone end information, estimated finger bone start information, and estimated finger mesh information.

In a third possible implementation form of a method according to the second implementation form of the third aspect, the finger bone end is the finger bone tip of a finger; the finger bone start is the first joint of a finger; and the finger mesh is a three dimensional surface representation of a finger.

In a fourth possible implementation form of a method according to the second or third implementation form of the third aspect, the method further comprises estimating the finger bone end information by using a curvature based algorithm on the sensor image and touch location information.

In a fifth possible implementation form of a method according to the second, third or fourth implementation form of the third aspect, the method further comprises estimating the finger bone start information by using a curvature based algorithm on the sensor image and the finger bone end information.

In a sixth possible implementation form of a method according to one of the second to fifth implementation form of the third aspect, the method further comprises estimating the finger mesh information by using the finger bone end information and the finger bone start information.

In a seventh possible implementation form of a method according to any implementation form of the third aspect or to the method as such, the method further comprises giving each finger in the finger skeletal model a unique identity, and using the unique identities for tracking the location of the hand or the finger.

In an eight possible implementation form of a method according to any implementation form of the third aspect or to the method as such, the hand/finger location indicates the location of the hand or the finger in relation to the hand or the finger detection device or the proximity sensor grid.

The advantages of the method according to the third aspect are the same as those for the corresponding implementation forms of the hand or finger detection device according to the first aspect.

The present disclosure also relates to a computer program, characterized in code means, which when run by processing means causes said processing means to execute any method according to the present disclosure. Further, the disclosure also relates to a computer program product comprising a computer readable medium and the computer program. The computer program is included in the computer readable medium and comprises of one or more from the following group: read-only memory (ROM), programmable read-only memory (PROM), erasable programmable read-only memory (EPROM), Flash memory, electrically erasable programmable read-only memory (EEPROM) and hard disk drive.

Further applications and advantages of the present disclosure will be apparent from the following detailed description.

### BRIEF DESCRIPTION OF THE DRAWINGS

The appended drawings are intended to clarify and explain different embodiments of the present disclosure, in which:

FIG. 1 shows a hand or a finger detection device according to an embodiment of the present disclosure;

FIG. 2 shows a computing device according to an embodiment of the present disclosure;

FIG. 3 shows a method according to an embodiment of the present disclosure;

FIG. 4 illustrates a further method according to an embodiment of the present disclosure;

FIG. 5 illustrates a further method according to an embodiment of the present disclosure;

FIG. 6 illustrates a further method according to an embodiment of the present disclosure;

FIG. 7 illustrates a further method according to an embodiment of the present disclosure; and

FIG. 8 illustrates a yet further method according to an embodiment of the present disclosure.

### DETAILED DESCRIPTION

In order for software applications to utilize the best or proper GUI and themes (e.g. the look of an application or how a GUI looks) there is a need to detect which hand or finger that is used to control and/or hold a computing device associated with the software applications. There are several software applications in which hand or finger detection will speed up or improve the use of the software application. Examples of such applications are text editors (for example, notes, short message service (SMS), messages, emails, chat, etc.), games (for example, multiplayer, 2 hands, landscape, etc.), graphics applications (for example, for painting), camera/gallery applications, Web browser applications, etc.

There are also cases when the GUI layouts, buttons and text are small because of the limited space of the input screen of the computing device (for example, a touch screen). Therefore, the GUI space could be increased by removing unnecessary GUI items if the computing device knows which hand and/or finger(s) is used by the user. Hence, in order for software applications to utilize the best GUI and themes for the user of the computing device there is a need to detect which hand and/or finger(s) is used for controlling the computing device.

For the above and further reasons, embodiments of the present disclosure relates to a hand or a finger detection device and to a method thereof.

FIG. 1 shows a hand or finger detection device 100 according to an embodiment of the present disclosure. The hand or finger detection device 100 comprises a proximity sensor grid 102 and a processor 106. The proximity sensor grid 102 comprises a plurality of proximity sensors 104 aligned in a grid to form the proximity sensor grid 102. The proximity sensor grid 102 is, in this example, a grid of proximity sensors in two (orthogonal) dimensions, for example, a grid in the X and Y directions.

A proximity sensor 104 is a sensor able to detect the presence of nearby objects/targets even without any physical contact with the object/target. A proximity sensor 104 often emits an electromagnetic field or a beam of electromagnetic radiation (for instance infrared), and looks for changes in the field or return signal. The object being sensed is often referred to as the proximity sensor's target which, in this case, is a hand and/or a finger. Different proximity sensor 104 targets demand different sensors. For example, a capacitive or photoelectric sensor might be suitable for a plastic target; an inductive proximity sensor always requires a metal target. Each proximity sensor 104 has a separate value which is a voltage (V) value, which depends on the distance between the proximity sensor 104 and the target.

Therefore, the proximity sensor grid 102 of the present hand or finger detection device 100 is configured to provide at least one sensor image to the processor 104 over suitable wireless or wired communication means as illustrated with the dashed arrow in FIG. 1. The sensor image is a proximity sensor grid representation of a hand or a finger in proximity to the proximity sensor grid 102. The processor 106 is configured to estimate a finger skeletal model of the hand or the finger based on the received sensor image. The processor 106 is further configured to determine a hand location or a finger location for the hand or the finger based on the estimated finger skeletal model. The processor 106 is further configured to output the hand location or the finger location information for further processing, such as for use in GUI control methods. In the example in FIG. 1 the hand or finger detection device 100 further comprises dedicated output means 108 configured to output hand location or finger location information. However, the dedicated output means 108 should be understood as optional.

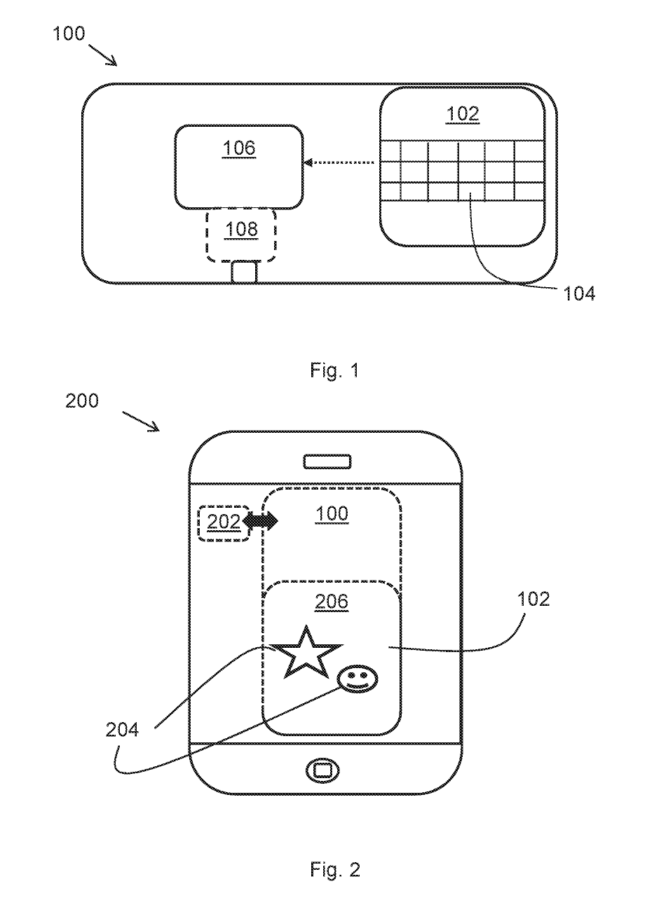

FIG. 2 shows a computing device 200 according to another embodiment of the present disclosure. The computing device 200 comprises at least one hand or finger detection device 100 described above. The computing device 200 further comprises a GUI control unit 202 configured to control GUI elements 204 of a GUI 206 (in this example a touch screen) of the computing device 200. The GUI is, in this example, a touch screen of the computing device 200. The GUI control unit 202 is configured to receive hand location information or finger location information for a hand or a finger in proximity to a proximity sensor grid 102 from the hand or finger detection device 100. The GUI control unit 202 is further configured to control the GUI elements 204 based on the hand location or the finger location information.

A suitable physical placement of the proximity sensor grid 102 is on the screen of the computing device 200 where a large surface area is available in relation to the actual physical screen. Hence, according to a further embodiment of the present computing device 200, the proximity sensor grid 102 is integrated in the GUI 206 itself. This is the case for the computing device 200 shown in FIG. 2 where the proximity sensor grid 102 is integrated in the touch screen of the computing device 200 (the grid is however not shown in FIG. 2).

According to a further embodiment of the present disclosure, the GUI control unit 202 of the computing device 200 is configured to control three dimensional GUI elements 204 based on three dimensional hand location information or finger location information.

Therefore, the GUI control unit 202 may be configured to arrange the GUI elements 204 in a plurality of different GUI user modes based on the hand location information or the finger location information. Each GUI user mode may correspond to a unique GUI layout.

In the following description examples of different applications of embodiments of the present computing device 200 are given.

Three dimensional control gestures can be created in third dimension by moving a hand or fingers closer to or farther away from the present proximity sensor grid 102 so that user does not need to touch the screen. Examples of use of mentioned three dimensional gestures are: zoom in or zoom out GUI elements; move GUI elements in three dimensions; rotate, move in and move out GUI elements in three dimensions; scale GUI elements, like a three dimensional shape presented on the computing device screen; use three dimensional gestures as a three dimensional pointer. The three dimensional pointer could be used to shape, draw, or otherwise manipulate the graphics presented on the computing device screen.

The GUI elements can be placed to the left or to the right on the screen depending on which hand that is being used by the user for holding and/or controlling the computing device 200. Examples of use are: in Call Mode—detect which hand that holds the computing device 200 so that control buttons can be moved to the side of the computing device 200; in Gallery Mode—set the scroll button on the left side or the right side of the computing device 200 depending on the holding hand of the user; in Edit Mode— auto select the keyboard theme/layouts (e.g. size, direction, orientation, etc.) so that keyboard buttons are moved to the side of the computing device 200 where the user's hand is holding the computing device 200; and in Game Mode—select multiple player mode or even single hand games mode.

Additionally, the hand or finger detection device 100 and/or computing device 200 could also have the capability to setup/register the hand orientation manually or automatically (e.g. switching ON/OFF a hand detection feature) based on the finger skeletal model.

Further, the GUI layouts can be optimized by removing or reducing input keys that are unnecessary or duplicated (e.g. two shift keys are not needed for some applications) and changing the touch screen keyboard shape based on hand or finger location information indicating which hand that holds and controls the computing device 200.

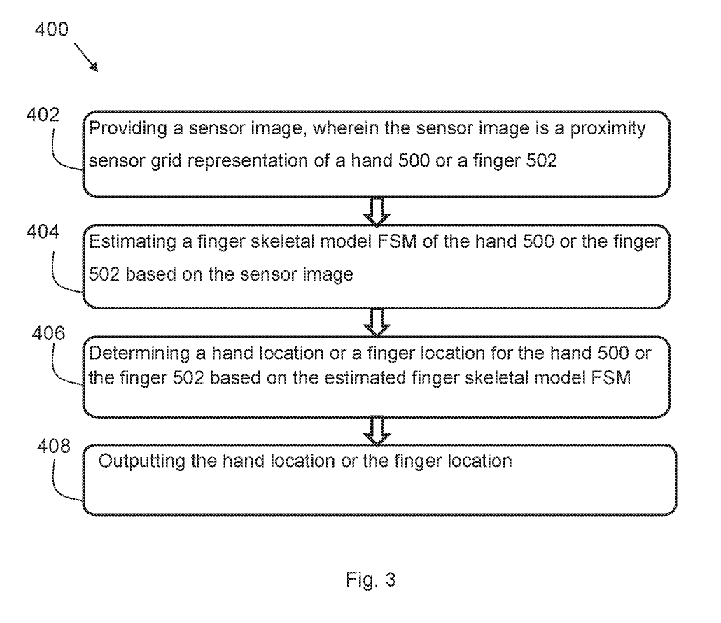

Furthermore, FIG. 3 shows a method 400 for hand or finger detection according to an embodiment of the present disclosure. The method may be executed in the hand or finger detection device 100, such as the one shown in FIG. 1. The method 400 comprises the step 402 of providing a sensor image. The sensor image is a proximity sensor grid representation of a hand 500 or a finger 502. The method 400 further comprises the step 404 of estimating a finger skeletal model (FSM) of the hand 500 or the finger 502 based on the sensor image. The method 400 further comprises the step 406 of determining a hand location or a finger location for the hand 500 or the finger 502 based on the estimated FSM. The method 400 finally comprises the step 408 of outputting the hand location or the finger location.

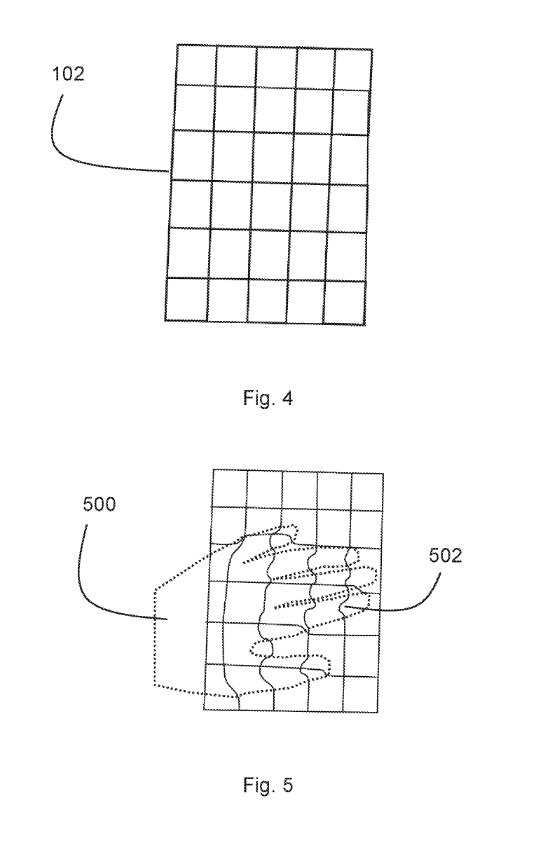

FIGS. 4-7 illustrate further embodiments of the present device 100 and present method 400 for hand or finger detection. The proximity sensor grid 102 provides sensor information from closely placed object/target (such as hand or fingers). Each proximity sensor 104 of the grid gives a separate value depending on its distance to the object/target. The proximity sensors 104, in an example, sense a “shadow” of the object/target. This shadow is a sensor image which is an image computed from sensor data collected from the proximity sensors 104 at a specific time instance t. The sensor image is forwarded as input to a hand or finger detection algorithm.

The hand or finger detection algorithm may also use history sensor image data, that is, data for previous sensor images associated with different previous time instances, for better end results in terms of distortion noise. Further, by using previous sensor images tracking movement of the hand or finger is possible or improved.

FIG. 4 shows an example of proximity sensor grid data when no object, such as hand or finger, is located close to the proximity sensors 104 of the proximity sensor grid 102. The sensor values are marked with example lines that represent the proximity of the object to the proximity sensor grid 102. This is a simplified example for illustration purpose only. In real applications, hundreds or thousands or millions of aligned proximity sensors 104 can be used in the proximity sensor grid 102.

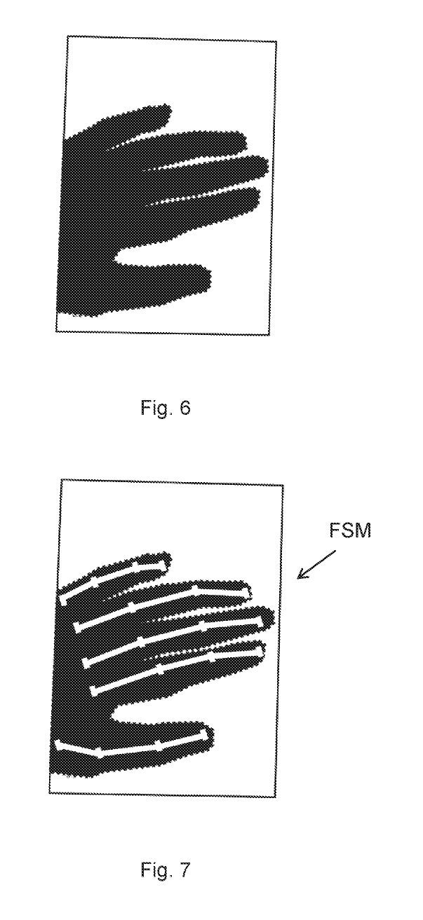

FIG. 5 shows the proximity sensor grid 102 in FIG. 4 influenced by a user's hand 500 and fingers 502. It can be see that the grid lines have been altered in areas where the user's hand 500 and fingers 502 are close to the proximity sensor grid 102. This change means that the sensor values are higher in the areas where the user's hand is near the proximity sensors 104.

FIG. 6 shows an example of a sensor image at a specific time instance t. The sensor image is used as input to the hand or finger detection algorithm that computes a best effort estimate of the hand or the finger location. Because the sensor image has proximity values per proximity sensor 104 a three dimensional model of the hand or finger can be computed. The stronger the value detected by a proximity sensor 104 the closer is the hand or finger to the proximity sensor 104.

FIG. 7 shows a FSM, marked in white in FIG. 7, from which hand or finger location information can be determined. From the FSM, the finger joint locations, orientation and lengths based on the most probable length of joints can be obtained. The FSM is computed based on the sensor images described above. From the hand or finger location information, it can be concluded if it is the right or the left hand, if one or both hands are used by the user, the location of the finger tips, etc. The hand or finger location information can be used as input to other applications, such as GUI control applications, etc.

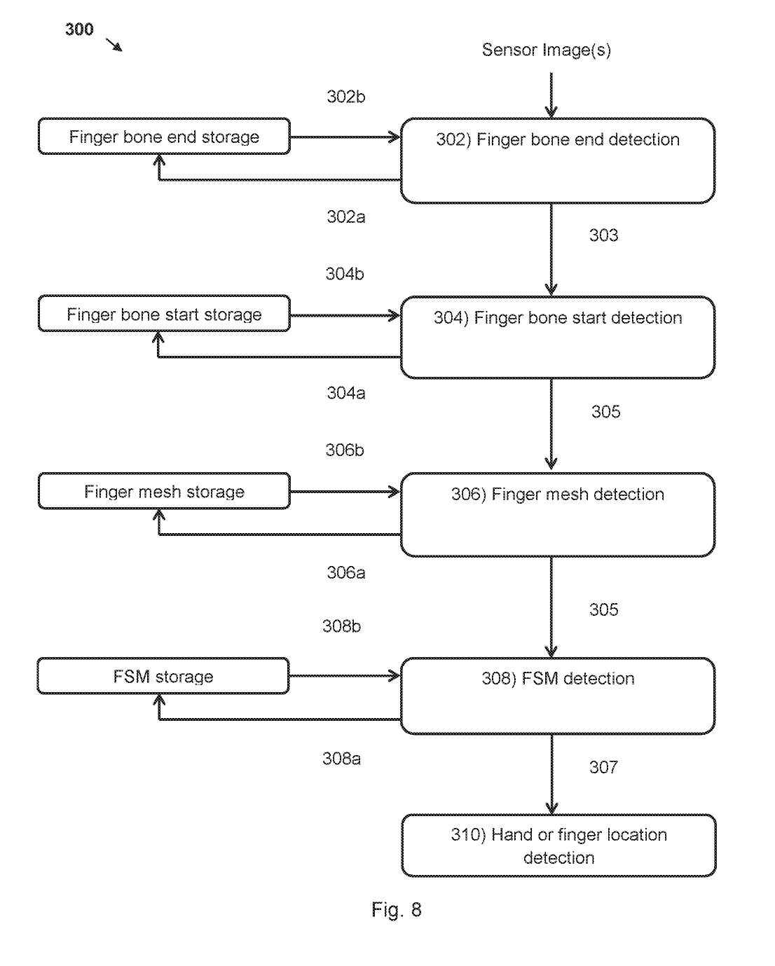

FIG. 8 shows a flow chart of a further method according to an embodiment of the present disclosure with a hand or finger detection algorithm 300.

Sensor image(s) are fed to the hand or finger detection algorithm 300. The hand or finger detection algorithm 300 mainly comprises five phases: finger bone end detection at step 302, finger bone start detection at step 304, finger mesh detection at step 306, FSM detection at step 308, and hand or finger detection location at step 310.

The sensor image(s) is fed to the hand or finger detection algorithm 300. Also in this step touch location information is fed to the hand or finger detection algorithm 300.

At step 302, for time instance t=0 (that is, the “current” time instance), the finger bone end is detected with a curvature based algorithm applied on the sensor image and the touch location information. In step 302a, current finger bone end information is stored in the finger bone end storage. In step 302b previous detected finger bone end information for previous time instances t−1, t−2, . . . , t−n is loaded.

Finger bone end denotes an ending point of a finger bone of a finger 502. Step 302 is used to find finger bone end from the sensor image. To find the finger bone end, a curvature based algorithm is applied on the sensor image and the touch location information is used. Determining touch locations can be done by, for example, using threshold values and comparing the threshold values with the values of the proximity sensors 104. The current finger bone end information is stored, at step 302a, in the finger bone end storage, which comprises finger bone end information for previous time instances t−1, t−2, . . . , t−n. The finger bone end detection, at step 302, also uses previous finger bone end information for detecting the current finger bone end information by loading, at step 302b, the information from the finger bone end storage as described above.

At step 303, the sensor image and the finger bone end information are transferred to the finger bone start detection at step 304.

At step 304, for time instance I=0, the finger bone start is detected with a curvature based algorithm and the finger bone end information from step 302. In step 304a, current finger bone start information is stored in the finger bone start storage. In step 304b, previous finger bone start information for previous time instances t−1, t−2, . . . , t−n is loaded.

Finger bone start denotes the first joint of the finger 502. The finger bone start detection, at step 304, also uses previous finger bone start information to detect the current finger bone start information by loading information from the finger bone start storage. The finger bone start detection, at step 304, uses the finger bone start storage to store the current finger bone start information.

At 305, the sensor image, the finger bone end information and the finger bone start information are transferred to the finger mesh detection at step 306.

At step 306, for time instance t=0, finger mesh is detected based on the sensor image, the finger bone end information and the finger bone start information from the previous steps 302 and 304. In step 306a, detected current finger mesh information is stored in the finger mesh storage. In step 306b, previous detected finger mesh information for previous time instances t−1, t−2, . . . , t−n is loaded.

Finger mesh denotes a three dimensional surface of the finger 502. The three dimensional mesh can, for example, use triangles having three dimensional corner points as data mesh format. The finger mesh detection 306 also uses previous finger mesh information to detect the current finger mesh information by loading, at step 306b, the previous finger mesh information from the finger mesh storage. The finger mesh detection, at step 306, uses the finger mesh storage for storing the current finger mesh information.

At step 305 the finger mesh information is transferred to the FSM detection at step 308.

At step 308, for time instance t=0, FSM is detected based on the finger mesh information. In step 308a, the current FSM is stored in the FSM storage. In step 308b, previous FSM is loaded from the FSM storage.

The FSM denotes a model of the finger bones and its joints in three dimensions. The FSM detection, at step 308, also uses previous FSM information to detect current FSM information by loading, at step 308b, previous FSM information for the previous time instances t−1, t−2, . . . , t−n from the FSM storage. The FSM detection, at step 308, uses the FSM storage to store current FSM.

At step 307, the detected FSM is transferred to the hand or finger location detection, at step 310, for determining the location of the hand or the finger.

Furthermore, any method according to the present disclosure may be implemented in a computer program, having code means, which when run by processing means causes the processing means to execute the steps of the method. The computer program is included in a computer readable medium of a computer program product. The computer readable medium may comprise of essentially any memory, such as a ROM, a PROM, an EPROM, a Flash memory, an EEPROM, or a hard disk drive.

Moreover, it is realized by the skilled person that the present hand or finger detection device 100 and computing device 200 comprises the necessary communication capabilities in the form of e.g., functions, means, units, elements, etc., for performing the present solution. Examples of such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, input means, output means, screens, displays, antennas, amplifiers, receiver units, transmitter units, digital signal processors (DSPs), mass storage devices (MSDs), trellis coded modulation (TCM) encoder, TCM decoder, power supply units, power feeders, communication interfaces, communication protocols, etc. which are suitably arranged together for performing the present solution.

Especially, the processors of the present devices may comprise, e.g., one or more instances of a Central Processing Unit (CPU), a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the present disclosure is not limited to the embodiments described above, but also relates to and incorporates all embodiments within the scope of the appended independent claims.

What is claimed is:

1. A detection device for a hand or a finger, comprising:
a plurality of proximity sensors forming a proximity sensor grid;
a processor coupled to the plurality of proximity sensors, wherein the processor is configured to:
estimate a finger skeletal model (FSM) of a hand or a finger based on the sensor image;
determine a hand location or a finger location for the hand or the finger respectively based on the estimated FSM, and
output the hand location or the finger location, wherein the proximity sensor grid is configured to provide a sensor image that is a representation of a hand or a finger in proximity to the proximity sensor grid.

2. The detection device according to claim 1, wherein the processor is further configured to:
receive a plurality of sensor images of the hand or the finger in proximity to the proximity sensor grid; and
estimate the FSM of the hand or the finger based on the plurality of sensor images.

3. The detection device according to claim 1, wherein the processor is configured to estimate the FSM by:
estimating information for each of a finger bone end, finger bone start, and finger mesh of the hand or the finger; and
estimating the FSM based on the estimated information for each of the finger bone end, finger bone start, and finger mesh.

4. The detection device according to claim 3, wherein the finger bone end is a finger bone tip of the finger, and wherein the finger bone start is a first joint of the finger, and the finger mesh is a three dimensional surface representation of the finger.

5. The detection device according to claim 3, wherein the processor is configured to estimate information for the finger bone end by applying a curvature based algorithm on the sensor image and touch location information.

6. The detection device according to claim 5, wherein the processor is configured to estimate information for the finger bone start by applying a curvature based algorithm on the sensor image and the finger bone end information.

7. The detection device according to claim 6, wherein the processor is configured to estimate the finger mesh information by using the information for the finger bone end and the information for the finger bone start.

8. The detection device according to claim 1, wherein the processor is further configured to:
assign each finger in the FSM a unique identity; and
use the unique identities for tracking the location of the hand or the finger.

9. The detection device according to claim 1, wherein the hand location and the finger location indicates the location of the hand and the finger respectively in relation to at least one of the detection device or the proximity sensor grid.

10. A computing device comprising:
a Graphical User Interface (GUI) with GUI control elements coupled to a detection device; and
a processor coupled to the GUI, wherein the processor is configured to:
provide hand location information or finger location information for a hand or a finger respectively in proximity to a proximity sensor grid of the detection device; and
control the GUI elements based on the hand location information or the finger location information.

11. The computing device according to claim 10, wherein the hand location information or the finger location information is three dimensional hand location information or finger location information, and wherein the processor is configured to control the GUI elements in three dimensions based on three dimensional information for at least one of the hand location or the finger location.

12. The computing device according to claim 10, wherein the processor is further configured to arrange the GUI elements in a plurality of different GUI user modes based on the information for the hand location or the finger location, wherein each GUI user mode of the plurality of GUI user modes corresponds to a unique GUI layout.

13. The computing device according to claim 10, wherein the proximity sensor grid is integrated in the GUI.

14. A detection method for a hand or a finger, comprising:
providing a sensor image of a hand or a finger, wherein the sensor image is a proximity sensor grid representation of the hand or the finger;
estimating a finger skeletal model (FSM) of the hand or the finger from the sensor image,
determining a hand location or a finger location for the hand or the finger respectively by applying the estimated FSM; and
outputting the hand location or the finger location.

15. A non-transitory computer readable medium including at least computer program code stored therein for hand or finger detection on a detection device associated with a computing device wherein when executed on a processor, the computer readable medium causes the processor to:
provide a sensor image of a hand or a finger, wherein the sensor image is a proximity sensor grid representation of the hand or the finger;
estimate a finger skeletal model (FSM) of the hand or the finger from the sensor image,
determine a hand location or a finger location for the hand or the finger respectively by applying the estimated FSM; and
output the hand location or the finger location.
